(19) United States
(12) Patent Application Publication
(10) Pub. No.: US 2024/0208720 A1
(43) Pub. Date: Jun. 27, 2024

(54) METHOD AND SYSTEM FOR COLLECTING OBJECTS

(71) Applicant: HCL Technologies Limited, New Delhi (IN)

(72) Inventors: RAKESH KUMAR SIDHARTHAN, Chennai (IN); J HARIPRASATH, Chennai (IN); SIVA SAKTHIVEL S, Chennai (IN); SUJEET KUMAR, Chennai (IN)

(21) Appl. No.: 18/393,722

(22) Filed: Dec. 22, 2023

(30) Foreign Application Priority Data
Dec. 24, 2022 (IN) 202211075316

(51) Int. Cl. B65F 1/00; B65F 1/14; B65F 1/16

(52) U.S. Cl. CPC B65F 1/004; B65F 1/14; B65F 1/16

(57) ABSTRACT

The invention relates to a system for collecting objects that includes a bin defining a space therewithin and a bin splitter assembly positioned within the bin. The bin splitter assembly may include a support stem oriented vertically and a plurality of bin splitters. Each of the plurality of bin splitters may be configured to be pivotably coupled with the support stem. Further, each of the plurality of bin splitters may define a wall extending radially away from the support stem and configured to split the space defined by the bin and create a pair of cabins with the bin across the wall. The support stem may be configured to rotate the plurality of bin splitters thereabout to reposition the plurality of bin splitters within the space defined by the bin to create different configurations of cabins within the bin.

### TECHNICAL FIELD

Generally, the invention relates to collecting objects, and more specifically to system and method of collecting and sorting objects in a bin having reconfigurable cabins.

### BACKGROUND

Object or waste segregation at the collection source can help in making the process of object or waste collection more efficient and also reduce environmental pollution. Proper segregation at the collection source ensures proper recycling of waste products which otherwise often end up in landfills, thereby generating pollution. Further, the segregation allows reuse of the products, thus minimizing the raw material requirements.

Several solutions are available to automate the waste segregation, however, these solutions are limited in terms of intelligence of segregating the waste on a broader category like metals, plastics, food products, etc.

Product users are primarily responsible for generating waste and in a smaller volume. It is preferred to use human intelligence to segregate such waste, as it is more accurate and allows for including multiple material categories like low-density polyethylene (LDPE) and high-density polyethylene (HDPE) in plastics. However, this requires training of the personnel and creating awareness among individuals on waste segregation procedures.

### SUMMARY

In one embodiment, a system for collecting objects is disclosed. The system may include a bin defining a space therewithin and a bin splitter assembly positioned within the bin. The bin splitter assembly may include a support stem oriented vertically and a plurality of bin splitters. Each of the plurality of bin splitters may be configured to be pivotably coupled with the support stem. Further, each of the plurality of bin splitters may define a wall extending radially away from the support stem and configured to split the space defined by the bin and create a pair of cabins with the bin across the planar wall. The support stem may be configured to rotate the plurality of bin splitters thereabout to reposition the plurality of bin splitters within the space defined by the bin to create different configurations of cabins within the bin.

In another embodiment, a method of collecting objects is disclosed. The method may include receiving a user input to create a target configuration of cabins within a bin. A plurality of bin splitters and a support stem are positioned within the bin. Each of the plurality of bin splitters may be configured to be pivotably coupled with the support stem. Further, each of the plurality of bin splitters may define a wall extending radially away from the support stem and configured to split a space defined by the bin and create a pair of cabins with the bin across the wall. The method may further include triggering an actuator to rotate at least one bin splitter of the plurality of bin splitters to reposition the at least one bin splitter within the space defined by the bin to create the target configuration of cabins within the bin, based on the user input.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals

FIG. 1 illustrates a schematic view of an environment with a system for collecting objects, in accordance with some embodiments of the present disclosure.

FIG. 2 illustrates a schematic top view of the system for collecting objects, in accordance with some embodiments.

FIG. 3 illustrates a schematic diagram of a bin control system, in accordance with some embodiments.

FIGS. 4A-4C illustrate various configurations of cabins created by selectively engaging different pairs of bin splitters with an actuator, in accordance with some embodiments.

FIG. 5 is a block diagram of the system of FIG. 1, in accordance with some embodiments.

FIG. 6 illustrates an example object (a bottle) along with its constituent parts, in accordance with some embodiments.

FIG. 7 is a flowchart of a process of collecting objects, in accordance with some embodiments.

FIG. 8 is a flowchart of a method of collecting objects, in accordance with some embodiments.

FIG. 9 is a flowchart of a method of creating a target configuration of cabins within the bin, in accordance with some embodiments.

FIG. 10 is an exemplary computing system that may be employed to implement processing functionality for various embodiments of the present disclosure.

### DETAILED DESCRIPTION OF THE DRAWINGS

The following description is presented to enable a user of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions). Software and firmware can be stored on computer-readable storage media. Some other processes can be implemented using analog circuitry, as is well known to one of ordinary skill in the art. Additionally, memory or other storage, as well as communication components, may be employed in embodiments of the invention.

The present subject matter relates to a system for collecting objects in a bin. For example, the bin is a circular bin with a central support stem. The support stem includes assemblies to hold bin splitters and to operate them. Further, the support stem includes provisions for mounting a camera and to hold a display unit. The camera may acquire images at a given viewpoint, where a user disposing an object is visible along with the object being disposed. Object identification is performed using a trained machine leaning model. The display further shows the identified object type, a dismantling procedure to dismantle the object into its constituent parts, and a corresponding bin for disposing each of the constituent parts. The display further displays an identity of the user and rewards for the successful object (waste) disposal along with overall reward points.

The conventional waste bins have predominantly equal sized cabins for each type of wastes with color codes or textual descriptions. The conventional bins occupy larger spaces and suffer from unequal filling of cabins. Inclusion of newer types of waste collection requires addition of more bins, thereby increasing the cost.

The system as disclosed by the present disclosure includes one bin to accommodate various waste types by splitting the bin into multiple cabins using bin splitters. As such, this system provides flexibility for including more waste types while occupying lesser space. Unequal filling of wastes can be accommodated in adjacent cabins.

Each of the bin splitters is attached with a roller at the end of it. The roller allows for smooth rolling of the bin splitter over the circumference of the bin. Any new addition of cabins requires a pair of bin splitters to be placed using the supporting stem. This enables flexibility to add or remove bin cabins based on requirements. The bin splitter is used to open and close the bin cabins. They are controlled by the bin control system which includes a lifter assembly made of rack and pinion arrangement. The lifter assembly is responsible for selection of corresponding cabin to open or close. The bin control system is configured to open or close the cabins. Further, the bin control system includes two couplers running in opposite directions, to control each bin splitter.

The bin control system uses a trained machine learning (ML) model to detect the type of object (waste) using object detection techniques. The detected object is classified into the corresponding category. The bin control system activates the bin splitters to open the corresponding cabin. Further, a description of the object and its disposal procedure is displayed on the display screen. Rewards for the waste disposal are updated in the corresponding user's account.

The camera is enabled to monitor the presence of human in its proximity. The user is expected to show the object in the field of view of the camera. Once the user and the object are detected, the object is classified into a category using the pretrained ML model. Further, dismantling procedure is displayed to enable user to dispose the object properly in separate cabins. The identified object and the corresponding bin in which it must be disposed is displayed on the display screen. The corresponding bin is opened using the bin control system. The bin control system waits till the time the object is disposed in the corresponding cabin. Once the object is disposed successfully, the bin will be closed by the bin control system.

The face recognition system tends to identify the user's name. If the user's name is identified correctly, then the reward will be announced and the same will be updated in the reward database. In order to cultivate the culture of proper waste disposal and segregation among the younger generations, the process of rewarding for waste disposal is included. On identification of a new face, the user's details will be collected using Forms available via a touch screen display unit.

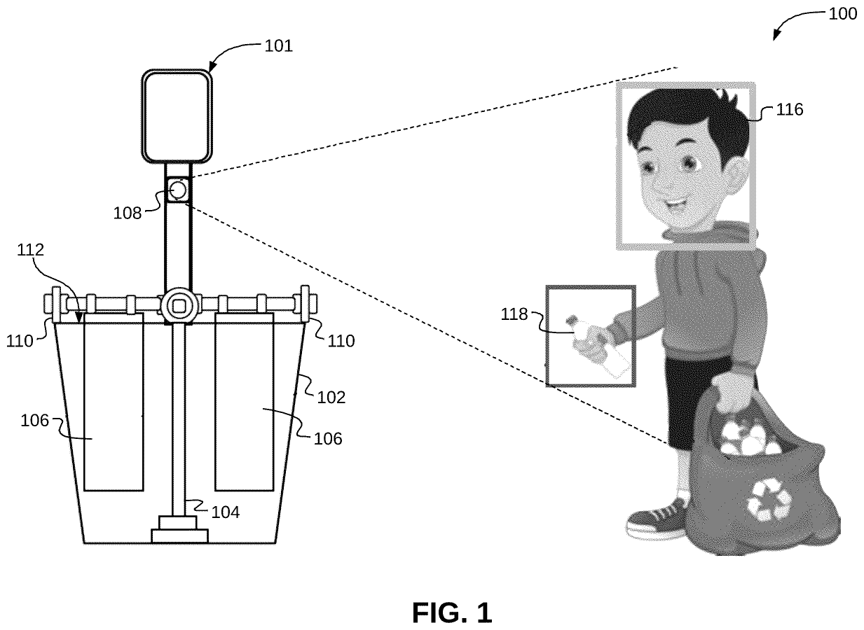

Referring now to FIG. 1, a schematic view 100 of an environment with a system 101 for collecting objects is illustrated, in accordance with some embodiments of the present disclosure. For example, the system 101 may be provided in a public place, including but not limited to, an airport lounge, an office space, a factory, a hospital, a school, etc. The system 101 may include a bin 102 defining a space therewithin. In some example embodiments, the top of the bin 102 may define a circular periphery. As such, the bin 102, for example, may include a cylindrical (having uniform circular profile/diameter throughout the height of the bin) or a frustoconical (having varying circular profile/diameter throughout the height of the bin) structure having a circular section.

The system 101 may further include a bin splitter assembly which may be positioned within the bin 102. The bin splitter assembly may include a support stem 104 oriented vertically. The support stem 104 may be an elongated shaft, with one end of the elongated shaft being fitted to a base of the bin 102. The bin splitter assembly may further include a plurality of bin splitters 106. Each of the plurality of bin splitters 106 may be configured to be pivotably coupled with the support stem 104. In other words, each of the plurality of bin splitters 106 may be coupled with the support stem 104 such that each of the plurality of bin splitters 106 is configured to rotate about the support stem 104. For example, each bin splitter 106 may be fitted into a vertically oriented slot formed on the support stem 104. Further, in some embodiments, each bin splitter 106 may be fixedly attached to the support stem 104, for example, via fasteners like screws, nuts, rivets, etc. However, in some preferred embodiments, each bin splitter 106 may be removably coupled with the support stem 104.

Each of the plurality of bin splitters 106 may define a wall. For example, each bin splitter 106 may include a substantially planar forming a wall. The wall may extend radially away from the support stem 104. Further, the wall may be configured to split the space defined by the bin 102 and create a pair of cabins with the bin 102 across the wall. The dimensions of the bin splitter 106 may be such that the wall snuggly fits in the bin between the support stem 104 and an inner surface of the bin 102 and is able to move within the space defined by the bin 102 under the rotation action of the support stem 104.

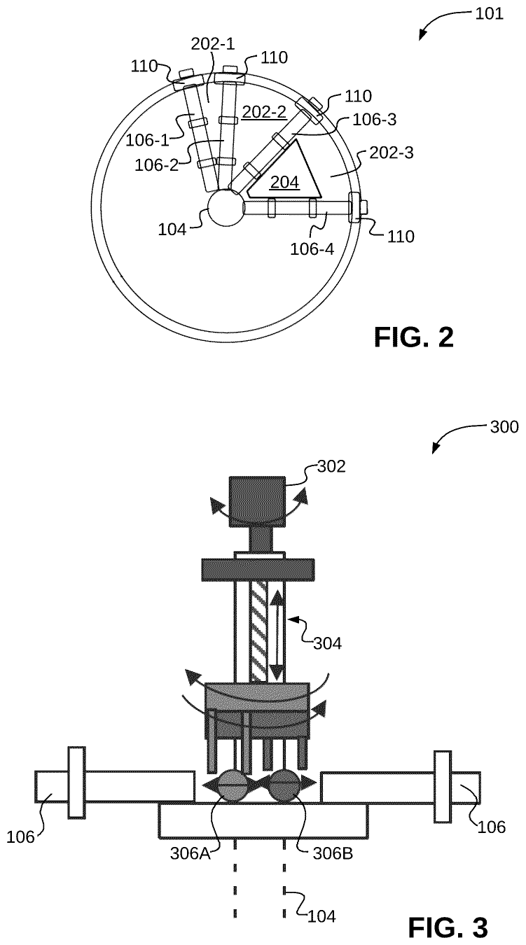

In some embodiments, the support stem 104 may be configured to rotate the plurality of bin splitters 106 thereabout to reposition the plurality of bin splitters 106 within the space defined by the bin 102 to create different configurations of cabins within the bin 102. By way of an example, as shown in FIG. 2, the support stem 104 may be positioned at the center of the bin 102. As such, the bin 102 may be configured in a circular shape. Further, the support stem 104 may be is configured to rotate the plurality of bin splitters 106 along the circular-periphery associated with the circular shape of the bin 102, around the support stem 104. However, it should be noted that the support stem 104 may be positioned may be positioned at alternate positions as well, for example, one corner of a bin which is shaped like a circular segment. As such, the support stem 104 may be positioned at an edge of the bin 102 and the bin 102 may be configured in a circle sector shape. The support stem 104 may be configured to rotate the plurality of bin splitters 106 along an arc-periphery associated with circle sector shape of the bin 102, the around the support stem (104).

Referring now to FIG. 2, a schematic top view of the system 101 for collecting objects is illustrated, in accordance with some embodiments. As shown in FIG. 2, the system 101 may include four bin splitters 106-1, 106-2, 106-3, 106-4. For example, as can be seen in FIG. 2, the bin splitters 106-1 and 106-2 may together create a cabin 202-1. Similarly, the bin splitters 106-2 and 106-3 may together create a cabin 202-2, and the bin splitters 106-3 and 106-4 may together create a cabin 202-3. As will be understood, the size of the cabins can be increased or decreased by a corresponding movement of the associated bin splitters of the plurality of bin splitters 106.

In an initial set up, the bins splitters 106 may be configured a way that no cabins are created, i.e. the bins splitters 106 are stacked close to each other. Based on the requirement, one or more cabins 202 may be created by selective movement of the bin splitters 106. For example, if one cabin is required, an associated pair of bin splitters may be rotated so as to create a space between therebetween defining the cabin.

In some embodiments, each of the plurality of bin splitters 106 may include a roller 110 attached at one end of the respective bin splitter 106. The roller 110 may be configured to contact with and move on a circumferential path 112 defined along a top end of the bin 102. As the bin splitter 106 rotated about the support stem 104 along one end, the opposite end of the bin splitter 106 is supported on the circumferential path 112 defined along the top end of the bin 102, via the roller 110. The roller 110, for example, may include a wheel configured to rotate about an axis along a radial length with the support stem 104 as the center. As such, the roller 110 may help in reducing friction between the respective beam splitter and the circumferential path 112 defined along the top end of the bin 102.

In some embodiments, as the cabin 202 is created between two bin splitters 106, a collection bag 204 may open for collecting the objects therewithin. For example, the collection bag 204 may be removably attached to the two respective bin splitters 106 and as the two respective splitters 106 move apart in order to create the cabin 202, the collection bag 204 may automatically be opened. The collection bag 204 may be made from a fabric or a flexible polymer sheet. Once the collection bag 204 is filled up with the collected objects, the collection bag 204 may be removed to be emptied or replaced with a fresh collection bag 204. It should be noted that the use of collection bag 204 is optional and in some embodiments, the objects may be dumped (collected) directly within the cabin 202, i.e. no collection bag 204 is used.

The system 101 may further include a bin control system. The bin control system, for example, for may be coupled to the support stem 104. In some embodiments, the bin control system may include an actuator (not shown in FIGS. 1-2, refer, FIG. 3) configured to couple with each of the plurality of bin splitters 106. The actuator may be further configured to cause rotation of each of the plurality of bin splitters 106. To this end, the actuator may be an electric motor (e.g. a DC motor, a stepper motor, a servo motor, etc.). The bin control system is further explained in conjunction with FIG. 3.

Referring now to FIG. 3, a schematic diagram of a bin control system 300 is illustrated, in accordance with some embodiments. As mentioned above, the bin control system 300 may be coupled to the support stem 104. As shown in FIG. 3, the bin control system 300 may include an actuator 302 configured to couple with each of the plurality of bin splitters 106. The actuator 302 may be further configured to cause rotation of each of the plurality of bin splitters 106.

The actuator 302 may be caused to electively engage with at least one (e.g. a pair) of the plurality of bin splitters 106, by a selector device 304 (also referred to as lifter assembly). In other words, depending on which pair of bin splitters 106 is to be rotated, the selector device 304 may selectively engage that pair of bin splitters 106 with the actuator 302. The selector device 304 may be configured to selectively engage at least one of the plurality of the bin splitters 106 with the actuator 302. The selector device 304, for example, may include a rack and pinion arrangement. The selector device 304 may be configured to select a pair of bin splitters 106 corresponding to the cabin which is to be opened/closed. In some embodiments, the selector device 304 may include a pair of couplers 306A, 306B configured to control each pair of bin splitters 106. The pair of couplers 306A, 306B may be configured to run in opposite directions. For example, couplers 306A, 306B may run in clockwise and anticlockwise direction, respectively to open the pair of bin splitters 106. Further, to close the pair of bin splitters 106, the couplers 306A, 306B may run in anticlockwise and clockwise direction, respectively. Once engaged, the actuator 302 may be configured to rotate the bin splitters 106 by a required degree to create a cabin of desired size.

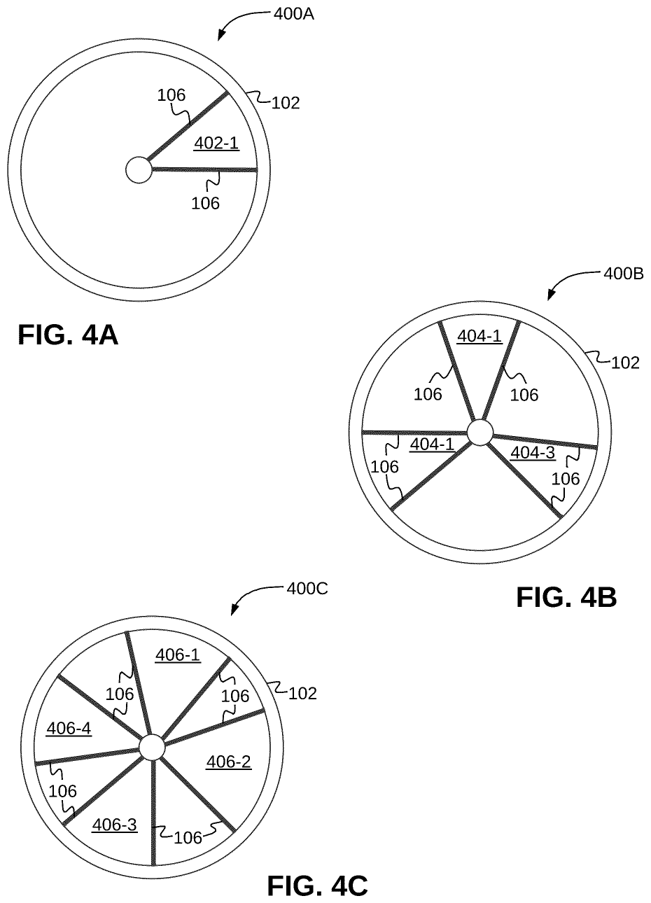

Various configurations of the cabins may be created by selectively engaging different pairs of bin splitters 106 with the actuator 302, as shown FIGS. 4A-4C. As shown in FIG. 4A, in a scenario 400A, one pair of bin splitters 106 may be selectively engaged with the actuator 302 to move the pair of bin splitters 106, to thereby create a cabin 402-1. Further, as shown in FIG. 4B, in a scenario 400B, three pairs of bin splitters 106 may be selectively engaged with the actuator 302 to move the three pairs of bin splitters 106, to thereby create three cabins 404-1, 404-2, 404-3. Furthermore, as shown in FIG. 4C, in a scenario 400C, four pairs of bin splitters 106 may be selectively engaged with the actuator 302 to move the four pairs bin splitters 106, to thereby create four cabins 406-1, 406-2, 406-3, 406-4.

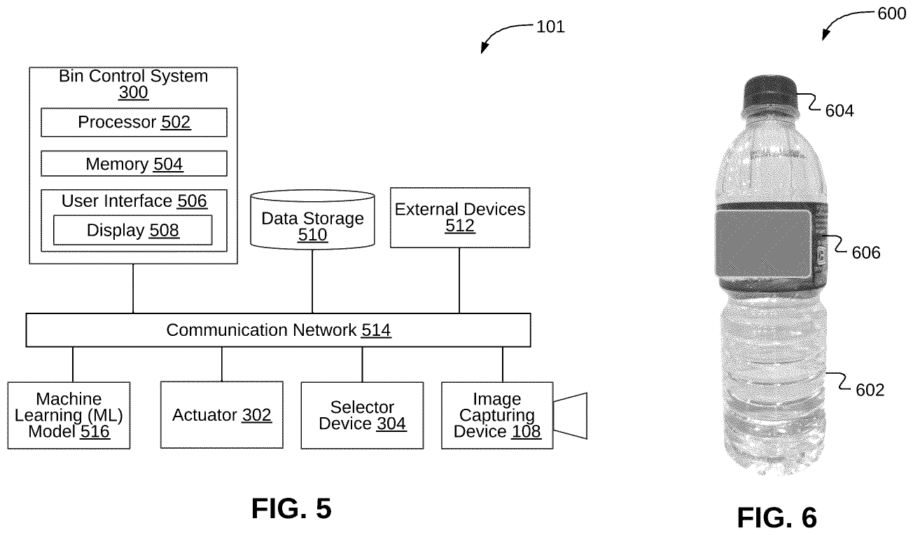

Referring now to FIG. 5, a block diagram of the system 101 is illustrated, in accordance with some embodiments. The system 101 may implement the bin control system 300. Further, the system 101 may include a data storage 510. The bin control system 300 may be a computing device having data processing capability. In particular, the bin control system 300 may have the capability for configuring the one or more cabins of the bin 102, and obtain images of a product being dispensed in the bin and of a user dispensing the object, process the images to identify the product type and an identity of the user, etc. Examples of the bin control system 300 may include, but are not limited to a desktop, a laptop, a notebook, a netbook, a tablet, a smartphone, a mobile phone, an application server, a web server, or the like.

Additionally, the bin control system 300 may be communicatively coupled to an external device 512 for sending and receiving various data. Examples of the external device 512 may include, but are not limited to, a remote server, digital devices, and a computer system. The bin control system 300 may connect to the external device 512 over a communication network 514. The bin control system 300 may connect to external device 512 via a wired connection, for example via Universal Serial Bus (USB). A computing device, a smartphone, a mobile device, a laptop, a smartwatch, a personal digital assistant (PDA), an e-reader, and a tablet are all examples of external devices 512.

The bin control system 300 may be configured to perform one or more functionalities that may include receiving a user input to create a target configuration of cabins 202 within the bin 102, triggering the actuator 302 to rotate at least one bin splitter 106 of the plurality of bin splitters 106 to reposition the at least one bin splitter 106 within the space defined by the bin 102 to create the target configuration of cabins 202 within the bin 102 based on the user input, receiving the images obtained by the image capturing device 108, detecting a type of the object captured in the image and classify the object into a corresponding category of a plurality of categories, using a trained machine learning (ML) model 516, and triggering the actuator 302 to rotate at least one bin splitter 106 of the plurality of bin splitters 106 to reposition the at least one bin splitter 106 within the space defined by the bin 102 to create a configuration of cabins 202 within the bin 102, based on at least one of the user input and the type of the object.

To perform the above functionalities, the bin control system 300 may include a processor 502 and a memory 504. The memory 504 may be communicatively coupled to the processor 502, and stores a plurality of instructions, which upon execution by the processor 502, cause the processor 502 to perform the above functionalities. Further, the bin control system 300 may implement a user interface 506, that may further implement a display 508 (also referred to as display screen 508 in this disclosure). Examples may include, but are not limited to a touch-based display, a keypad, a microphone, audio speakers, a vibrating motor, LED lights, etc. The user interface 506 may receive input from a user and also display an output of the computation performed by the bin control system 300.

The image capturing device 108 may be configured to obtain images of a user 116 and at least one object 118 held and dumped by the user 116 in the bin 102, as shown in FIG. 1. For example, the image capturing device 108 may be a camera such as a complementary metal oxide semiconductor (CMOS) or a charge-coupled device (CMOS) based camera. The image capturing device 108 may be mounted on the bin 102 at a suitable that affords the image capturing device 108 a view of both the user 116 and the object 118 being dumped in the bin 102. As such, the image capturing device 108 may be mounted at a predetermined elevation from the ground level. For example, as shown in FIG. 1, the image capturing device 108 may be mounted on a extended length of the support stem 104.

Further, the image capturing device 108 may be configured to obtain still images or a video. Furthermore, in some embodiments, the image capturing device 108 may be configured to first detect the presence of the user 116 or the object 118, before it starts capturing the images—this allows the image capturing device 108 to work more efficiently and avoid capturing and generating unnecessary data.

As shown in FIG. 5, the image capturing device 108 may be communicatively coupled with the bin control system 300, via a wired communication network or a wireless communication network. The bin control system 300 may control the image capturing device 108 may cause the image capturing device 108 to start capturing the images when required. Once the image capturing device 108 has captured the images, the bin control system 300 may receive the images obtained by the image capturing device 108. Further, the bin control system 300 may detect a type of the object captured in the image and classify the object into a corresponding category of a plurality of categories, using the trained deep learning (DL) model 516.

It should be noted that the plurality of categories may be predefined. For example, the plurality of categories may correspond to the type of object detected, such as a packaging (bottles, cutlery, boxes, etc.), food product/wastage, material of the object (plastic, metal, etc.), and so on. It should be further noted that it may be desirable to collect the object belonging to different categories in different cabins of the bin 102. For example, all the food products/wastage may be collected in a one cabin and empty bottles may be collected in another cabin. Further, in some scenarios, it may be desirable to collect different constituent parts of an object in different cabins of the bin 102. This is because different constituent parts may be made from different materials, therefore, components made from same or similar materials may be collected together in a common cabin. FIG. 6 illustrates an example object 600—a bottle, along with its constituent parts. For example, as shown in FIG. 6, the example object 600 may include a bottle body 602, a cap 604, and a label 606. For example, the bottle 602 may be made from Polyethylene Terephthalate (PET), the cap 604 may be made from High density PET, and the label may be made from Polypropylene (e.g. Biaxially Oriented Polypropylene Films or BOPP). As will be understood, the cap 604 may be screwed onto an opening of the bottle body 602, and the label may be attached to the outer surface of the bottle body 602. It may be, therefore, desired to collect these constituent parts (the bottle body 602, the cap 604, and the label 606) in three separate cabins 202 of the bin 102.

To this end, the bin control system 300 may select the at least one at least one bin splitter 106 from the plurality of bin splitters 106, based on the user input or the type of the object detected. Further, the bin control system 300 may request the selector device 304 to selectively engage the at least one of the plurality of the bin splitters 106 (i.e. the selected bin splitters 106) with the actuator 302. As such, the selector device 304 which may be communicatively coupled with the bin control system 300 may selectively engage at least one of the plurality of the bin splitters 106 with the actuator 302. Further, the bin control system 300 may trigger the actuator 302 to rotate at least one bin splitter 106 of the plurality of bin splitters 106 to reposition the at least one bin splitter 106 within the space defined by the bin 102 to create a configuration of cabins 202 within the bin 102. It should be noted that the configuration of the cabins (for example, number of cabins 202, size of the cabins 202, etc.) may be based on user input received from a user or type of the object as detected by the bin control system 300 using the DL model 516. For example, the bin control system 300 may trigger the actuator 302 to rotate three pairs of bin splitters 106 to reposition them so as to create three cabins 202 within the bin 102, corresponding to the bottle body 602, the cap 604, and the label 606.

In some embodiments, the bin control system 300, upon detecting the user 116 and the object being disposed, may provide visual instructions to the user 116 for dismantling the object 118 into its constituent parts before the user 116 disposes them into their respective cabins 202 of the bin 102. To this end, the bin control system 300 further includes the display screen 508. The bin control system 300, upon detecting the type of the object 118 captured in the image, may determine a dismantling procedure associated with the object 116. For example, the dismantling procedure may be fetched from the data storage 510 which may store a database of dismantling procedures for a large set of different types of objects 118. Alternately, the dismantling procedure may be determined using a DL model, which may have been previously trained for classifying the objects into respective categories and match them with the associated dismantling procedure.

The bin control system 300 may further display a graphical representation of the dismantling procedure associated with the object 118, via the display screen 508. This enables the user 116 to dismantle the object 118 into its one or more constituent parts, and further enable the user 116 to dump each of the one or more constituent parts into a respective cabin 220 associated with the configuration of the cabins 202. The dismantling procedure, for example, may display what the different constituent parts of the object 118 are and how to detach each of them from the object. The dismantling procedure may further provide an indication to the user 116 as to which cabin of the plurality of cabins is to be used for disposing each of the constituent parts of the object 118. Further, in some embodiments, the bin control system 300 may orient a respective cabin towards the user 116 corresponding to the constituent part being disposed—for example, the bin 102 may be configured to rotate on an axis to thereby cause reorientation of the cabins 202 relative to the position of the user 116.

In some embodiments, the based on the images of the user, the bin control system 300 may determine an identity of the user 116 captured in the image. The identity of the user 116 may be determined using any conventional face recognition model. To this end, a database of facial feature information of a plurality of users may be retrieved from the data storage 510. The facial features information of the user 116 as detected by the face recognition model may be mapped with the database, to thereby determine the identity of the user. This may be particularly useful in a facilities like offices and schools, where the identities of the users present is usually known. When a new user is detected (i.e. whose information is not present in the database), the bin control system 300 may prompt the user to enter their details so as to add the identity of the new user to the database. Once the user is detected or new user profile is created, a record of dumping of the object by the user may be logged in the database along with the type of the object dumped.

Further, in some embodiments, reward points may be awarded to the users once they have successful dumped the object within the bin 102. As such, historical data is created for the users that can later help in understanding the user behavior towards waste disposal.

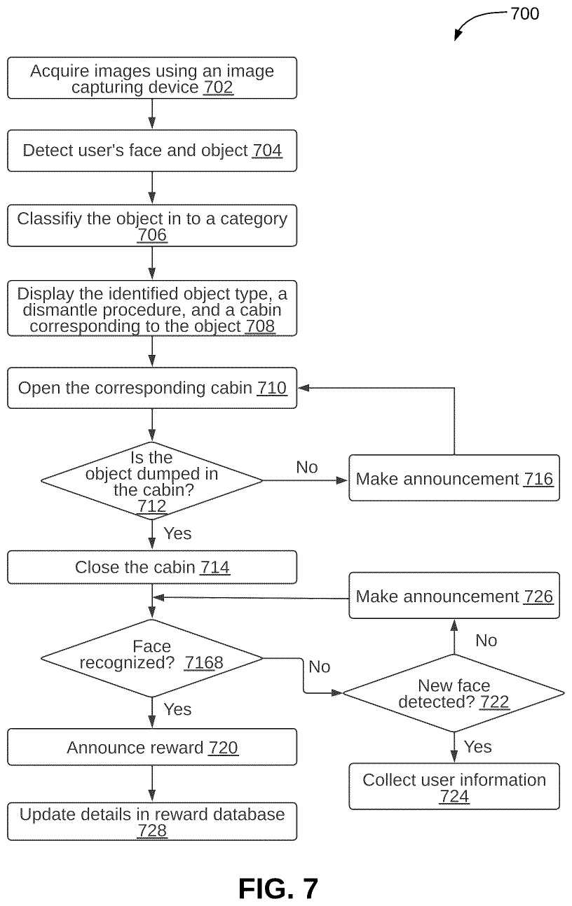

Referring now to FIG. 7, a flowchart of a process 700 of collecting objects is illustrated, in accordance with some embodiments. The process 700 is explained in conjunction with FIGS. 1-6.

At step 702, images may be acquired by the image capturing device 108. The bin 102 may include a provision to mount the image capturing device 108, for example, on an extended length of the support stem 104. The image capturing device 108 may be configured to acquire the images at a given viewpoint, where the user 116 and object 118 are visible. At step 704, face detection of the user 116 and object detection of the object 118 may be performed corresponding to the image captured by the image capturing device 108. At step 706, a type of the object 118 captured in the image may be determined. Further, the object may be classified into a corresponding category of a plurality of categories, using the trained ML model 516.

At step 708, the determined object type, a dismantling procedure associated with the detected object, and bins corresponding to each of the constituent parts of the object may be displayed to the user, via the display 508. To this end, a display screen 508 may be provided on the system 101 at a suitable location which is easily visible to the user 116. The display screen 508 may also display the identified user 116 and rewards for the successful waste disposal of the object 118 along with overall reward points recorded for the user 116.

At step 710, the corresponding bin 202 may be opened, via the movement of the corresponding bin splitters 106. The bin splitters 106 are controlled by the bin control system 300. As described above, the bin control system 300 may include a selector device 304 (lifter assembly) comprising rack and pinion arrangement. The selector device 304 may be configured to select the bin splitters 106 for a corresponding cabin 202 to open or close. The bin control system 300 may further include the pair of couplers 306 (running in opposite directions) to move a pair of bin splitter 106 to open or close the cabin 202.

At step 712, a check may be performed to detect whether the object has been successfully disposed in the corresponding cabin or not. If it is determined that the object has been successfully disposed in the corresponding cabin, the process 700 may proceed to step 714 (“Yes” path) where the cabin 202 is closed after the object is disposed successfully therein. However, if at step 712, it is determined that the object has not been successfully disposed in the corresponding cabin, the process 700 may proceed to step 716 (“No” path) where a voice or a visual announcement may be made for the user 116 to know and make another attempt for successful disposal of the object.

At step 718, a check may be performed to determine whether the face recognition performed at step 704 matches with an identity already stored in the database. In other words, it is checked whether the identity of the user 116 disposing off the object 118 is successfully determined or not. If the identity of the user 116 is successfully determined, the process 700 may proceed to step 720 (“Yes” path) at which rewards for the identified user may be announced. Further, at step 728, the reward information may be updated in the database.

If at step 718, the identity of the user 116 disposing off the object 118 is not successfully determined, the process 700 may proceed to step 722 (“No” path) at which a check may be performed to query whether a new face is detected. If at step 722, it is determined that a new face is detected, then the process may proceed to step 724 (“Yes” path) at which the user may be prompted to provide their profile and the database may be updated with the information about the identity of the new user. However, if at step 722, it is determined that a new face is not detected, then the process 700 may proceed to step 726 (“No” path) at which an audio or visual announcement may be made to notify the user for providing another image(s) for reperforming the face recognition. The process 700 may accordingly once again proceed to step 718.

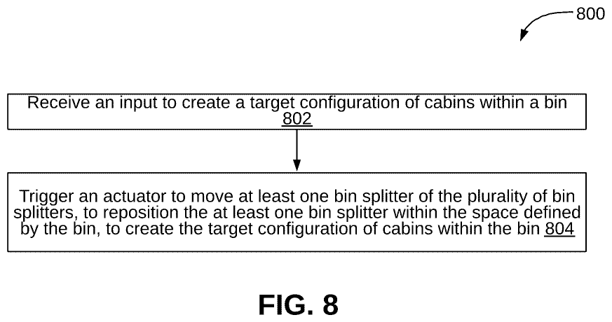

Referring now to FIG. 8, a flowchart of a method 800 of collecting objects is illustrated, in accordance with some embodiments. The method 800 may be performed by the bin control system 300. The method 800 is explained in conjunction with FIGS. 1-6.

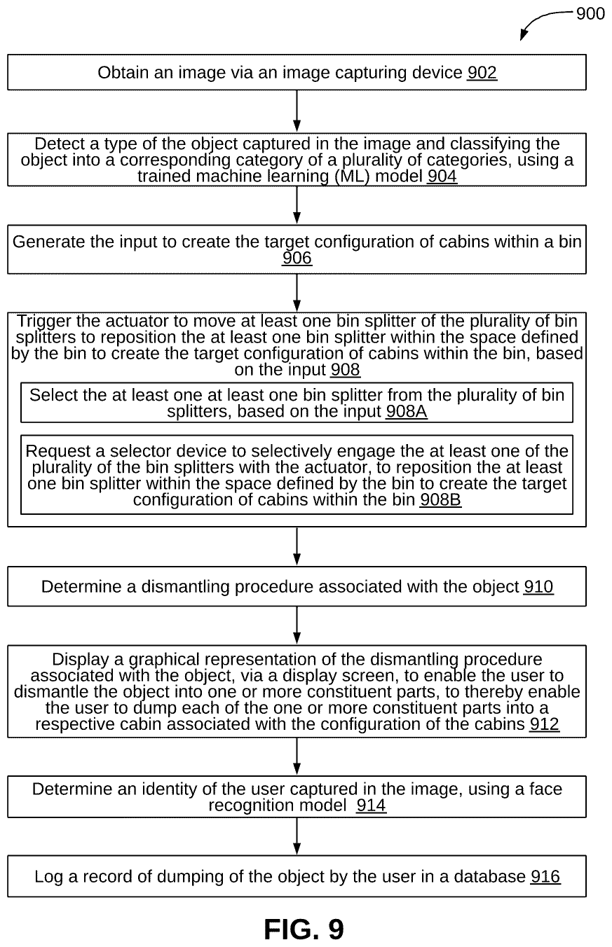

At step 802, an input to create a target configuration of cabins 202 within the bin 102 may be received. As mentioned above, a plurality of bin splitters 106 may be positioned within the bin 102. Each of the plurality of bin splitters 106 may be configured to move within the space defined by the bin 102. Further, each of the plurality of bin splitters 106 may define a wall configured to split the space defined by the bin 102 and create at least one cabin 202 within the bin 102 across the wall. At step 804, the actuator 302 may be triggered to move at least one bin splitter 106 (of the plurality of bin splitters), to reposition the at least one bin splitter 106 within the space defined by the bin 102, to create the target configuration of cabins 202 within the bin 102. The step 804 is further explained in detail in conjunction with FIG. 9.

Referring now to FIG. 9, a flowchart of a method 900 of creating the target configuration of cabins within the bin is illustrated, in accordance with some embodiments. The method 900 may be performed by the bin control system 300.

At step 902, an image may be obtained via the image capturing device 108. At step 904, a type of the object 118 captured in the image may be identified and the object 118 may be classified into a corresponding category of a plurality of categories, using the trained machine learning (ML) model 516. At step 906, an input may be generated to create the target configuration of cabins 202 within the bin 102. Further, at step 908, the actuator 302 may be triggered to move at least one bin splitter 106 (of the plurality of bin splitters) to reposition the at least one bin splitter 106 within the space defined by the bin 102 to create the target configuration of cabins 202 within the bin 102, based on the input. It should be noted that in some embodiments, in order to trigger the actuator 302 to rotate at least one bin splitter 106, step 908A-908B may be performed. At step 908A, the at least one at least one bin splitter 106 may be selected from the plurality of bin splitters, based on the input. At step 908B, the selector device 304 may be requested to selectively engage the at least one of the plurality of the bin splitters 106 with the actuator 302, to reposition the at least one bin splitter 106 within the space defined by the bin 102 to create the target configuration of cabins 202 within the bin 102.

At step 910, upon detecting the type of the object 118 captured in the image, a dismantling procedure associated with the object 118 may be determined. At step 912, a graphical representation of the dismantling procedure associated with the object 118 may be displayed, via the display screen 508. The graphical representation of the dismantling procedure may enable the user 116 to dismantle the object 118 into one or more constituent parts. As such, the user 116 is enabled to dump each of the one or more constituent parts into a respective cabin 202 associated with the configuration of the cabins 202.

At step 914, once the user 116 has dumped the object 118 in the respective cabin of the bin 102, an identity of the user 116 captured in the image may be determined, using a face recognition model. At step 916, a record of dumping of the object 118 by the user 116 may be logged in a database.

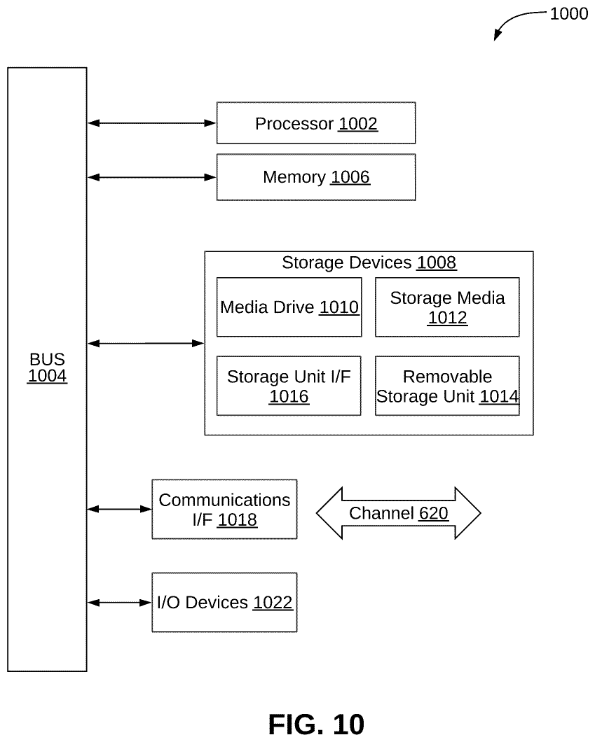

Referring now to FIG. 10, an exemplary computing system 1000 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1000 may represent, for example, a user device such as a desktop, a laptop, a mobile phone, personal entertainment device, DVR, and so on, or any other type of special or general-purpose computing device as may be desirable or appropriate for a given application or environment. The computing system 1000 may include one or more processors, such as a processor 1002 that may be implemented using a general or special purpose processing engine such as, for example, a microprocessor, microcontroller or other control logic. In this example, the processor 1002 is connected to a bus 1004 or other communication media. In some embodiments, the processor 1002 may be an Artificial Intelligence (AI) processor, which may be implemented as a Tensor Processing Unit (TPU), or a graphical processor unit, or a custom programmable solution Field-Programmable Gate Array (FPGA).

The computing system 1000 may also include a memory 1006 (main memory), for example, Random Access Memory (RAM) or other dynamic memory, for storing information and instructions to be executed by the processor 1002. The memory 1006 also may be used for storing temporary variables or other intermediate information during the execution of instructions to be executed by processor 1002. The computing system 1000 may likewise include a read-only memory (“ROM”) or other static storage device coupled to bus 1004 for storing static information and instructions for the processor 1002.

The computing system 1000 may also include storage devices 1008, which may include, for example, a media drive 1010 and a removable storage interface. The media drive 1010 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1012 may include, for example, a hard disk, magnetic tape, flash drive, or other fixed or removable media that is read by and written to by the media drive 1010. As these examples illustrate, the storage media 1012 may include a computer-readable storage medium having stored therein particular computer software or data.

In alternative embodiments, the storage devices 1008 may include other similar instrumentalities for allowing computer programs or other instructions or data to be loaded into the computing system 1000. Such instrumentalities may include, for example, a removable storage unit 1014 and a storage unit interface 1016, such as a program cartridge and cartridge interface, a removable memory (for example, a flash memory or other removable memory module) and memory slot, and other removable storage units and interfaces that allow software and data to be transferred from the removable storage unit 1014 to the computing system 1000.

The computing system 1000 may also include a communications interface 1018. The communications interface 1018 may be used to allow software and data to be transferred between the computing system 1000 and external devices. Examples of the communications interface 1018 may include a network interface (such as an Ethernet or other NIC card), a communications port (such as for example, a USB port, a micro-USB port), Near field Communication (NFC), etc. Software and data transferred via the communications interface 1018 are in the form of signals which may be electronic, electromagnetic, optical, or other signals capable of being received by the communications interface 1018. These signals are provided to the communications interface 1018 via a channel 1020. The channel 1020 may carry signals and may be implemented using a wireless medium, wire or cable, fiber optics, or other communications medium. Some examples of the channel 1020 may include a phone line, a cellular phone link, an RF link, a Bluetooth link, a network interface, a local or wide area network, and other communications channels.

The computing system 1000 may further include Input/Output (I/O) devices 1022. Examples may include, but are not limited to a display, keypad, microphone, audio speakers, vibrating motor, LED lights, etc. The I/O devices 1022 may receive input from a user and also display an output of the computation performed by the processor 1002. In this document, the terms “computer program product” and “computer-readable medium” may be used generally to refer to media such as, for example, the memory 1006, the storage devices 1008, the removable storage unit 1014, or signal(s) on the channel 1020. These and other forms of computer-readable media may be involved in providing one or more sequences of one or more instructions to the processor 1002 for execution. Such instructions, generally referred to as “computer program code” (which may be grouped in the form of computer programs or other groupings), when executed, enable the computing system 1000 to perform features or functions of embodiments of the present invention.

In an embodiment where the elements are implemented using software, the software may be stored in a computer-readable medium and loaded into the computing system 1000 using, for example, the removable storage unit 1014, the media drive 1010 or the communications interface 1018. The control logic (in this example, software instructions or computer program code), when executed by the processor 1002, causes the processor 1002 to perform the functions of the invention as described herein.

Systems and techniques for collecting and sorting objects, such as waster objects are disclosed in the above disclosure. Among various other application areas, the above system can be used in offices and factories to train operators on sorting the components (like capacitors, resistors, or any other electronic components) to specific bins. A Machine Leaning (ML) model is trained to recognize the components (constituent parts of the object) instead of the overall object. As such, with the help of camera and the ML model, the components are detected, sorted, and collected in respective cabins of the bin. The system helps in creating awareness on proper way of waste disposal and segregation among the users. Further, the reward-based training system motivates the users to follow waste disposal guidelines. The above system is capable of accommodating various types of wastes using a single bin and segregating the bin into multiple cabins, which significantly reduces the space requirements. The reconfigurable bin splitters make the overall system more flexible and customizable, based on the application area. Furthermore, computer vision-based waste detection enables segregating multiple types of objects/wastes.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A system for collecting objects, the system comprising:
a bin defining a space therewithin; and
a bin splitter assembly positioned within the bin, the bin splitter assembly comprising:
a support stem oriented vertically; and
a plurality of bin splitters, each of the plurality of bin splitters configured to be pivotably coupled with the support stem, each of the plurality of bin splitters defining a wall extending radially away from the support stem and configured to split the space defined by the bin and create a pair of cabins with the bin across the wall,
wherein the support stem is configured to rotate the plurality of bin splitters thereabout to reposition the plurality of bin splitters within the space defined by the bin to create different configurations of cabins within the bin.

2. The system of claim 1, wherein each of the plurality of bin splitters comprises:
a roller attached at one end of the respective bin splitter, the roller configured to contact with and move on a circumferential path defined along a top end of the circular bin.

3. The system of claim 1 further comprising a bin control system coupled to the support stem, the bin control system comprising:
an actuator configured to couple with each of the plurality of bin splitters, the actuator further configured to cause rotation of each of the plurality of bin splitters;
a processor; and
a memory communicatively coupled with the processor and storing processor-executable instructions, which on execution by the processor, cause the processor to:
receive a user input to create a target configuration of cabins within the bin; and
trigger the actuator to rotate at least one bin splitter of the plurality of bin splitters to reposition the at least one bin splitter within the space defined by the bin to create the target configuration of cabins within the bin, based on the user input.

4. The system of claim 3 further comprising:
an image capturing device configured to obtain images of a user and at least one object held and dumped by the user in the bin.

5. The system of claim 4 wherein the processor-executable instructions further cause the processor to:
receive the images obtained by the image capturing device;
detect a type of the object captured in the image and classify the object into a corresponding category of a plurality of categories, using a trained machine learning (ML) model; and
trigger the actuator to rotate at least one bin splitter of the plurality of bin splitters to reposition the at least one bin splitter within the space defined by the bin to create a configuration of cabins within the bin, based on at least one of the user input and the type of the object.

6. The system of claim 5 further comprising:
a selector device communicatively coupled with the bin control system, wherein the selector device is configured to selectively engage at least one of the plurality of the bin splitters with the actuator.

7. The system of claim 6 wherein triggering the actuator to rotate at least one bin splitter of the plurality of bin splitters comprises:
selecting the at least one at least one bin splitter from the plurality of bin splitters, based on at least one of the user input and the type of the object; and
requesting the selector device to selectively engage the at least one of the plurality of the bin splitters with the actuator, to reposition the at least one bin splitter within the space defined by the bin to create the target configuration of cabins within the bin.

8. The system of claim 5, wherein the bin control system further comprises a display screen.

9. The system of claim 8, wherein the processor-executable instructions further cause the processor to:
upon detecting the type of the object captured in the image, determining a dismantling procedure associated with the object; and
displaying a graphical representation of the dismantling procedure associated with the object, via the display screen, to enable the user to dismantle the object into one or more constituent parts, to thereby enable the user to dump each of the one or more constituent parts into a respective cabin associated with the configuration of the cabins.

10. The system of claim 1, wherein the processor-executable instructions further cause the processor to:
determine an identity of the user captured in the image, using a face recognition model; and
logging a record of dumping of the object by the user in a database.

11. The system of claim 1, wherein the support stem is positioned at the centre of the bin, the bin configured in a circular shape, and
wherein the support stem is configured to rotate the plurality of bin splitters along the circular-periphery associated with the circular shape of the bin, around the support stem.

12. The system of claim 1,
wherein the support stem is positioned at an edge of the bin, the bin configured in a circle sector shape, and
wherein the support stem is configured to rotate the plurality of bin splitters along an arc-periphery associated with circle sector shape of the bin, the around the support stem.

13. A method of collecting objects, the method comprising:
receiving, by a bin control device, an input to create a target configuration of cabins within a bin,
wherein a plurality of bin splitters are positioned within the bin, each of the plurality of bin splitters configured to move within a space defined by the bin, each of the plurality of bin splitters defining a wall configured to split the space defined by the bin and create at least one cabin within the bin across the wall; and
triggering, by the bin control device, an actuator to move at least one bin splitter of the plurality of bin splitters, to reposition the at least one bin splitter within the space defined by the bin, to create the target configuration of cabins within the bin.

14. The method of claim 13, wherein creating the target configuration of cabins within the bin further comprises:
obtaining an image via an image capturing device;
detecting a type of the object captured in the image and classifying the object into a corresponding category of a plurality of categories, using a trained machine learning (ML) model;
generating the input to create the target configuration of cabins within a bin; and
triggering the actuator to move at least one bin splitter of the plurality of bin splitters to reposition the at least one bin splitter within the space defined by the bin to create the target configuration of cabins within the bin, based on the input, wherein triggering the actuator to rotate at least one bin splitter of the plurality of bin splitters comprises:
selecting the at least one at least one bin splitter from the plurality of bin splitters, based on the input; and
requesting a selector device to selectively engage the at least one of the plurality of the bin splitters with the actuator, to reposition the at least one bin splitter within the space defined by the bin to create the target configuration of cabins within the bin.

15. The method of claim 13, further comprising:
upon detecting the type of the object captured in the image, determining a dismantling procedure associated with the object; and
displaying a graphical representation of the dismantling procedure associated with the object, via a display screen, to enable the user to dismantle the object into one or more constituent parts, to thereby enable the user to dump each of the one or more constituent parts into a respective cabin associated with the configuration of the cabins.

16. The method of claim 13, further comprising:
determining an identity of the user captured in the image, using a face recognition model; and
logging a record of dumping of the object by the user in a database.

17. A non-transitory computer-readable medium storing computer-executable instructions for collecting objects, the computer-executable instructions configured for:
receiving an input to create a target configuration of cabins within a bin,
wherein a plurality of bin splitters are positioned within the bin, each of the plurality of bin splitters configured to move within a space defined by the bin, each of the plurality of bin splitters defining a wall configured to split the space defined by the bin and create at least one cabin within the bin across the wall; and
triggering an actuator to move at least one bin splitter of the plurality of bin splitters, to reposition the at least one bin splitter within the space defined by the bin, to create the target configuration of cabins within the bin.

18. The non-transitory computer-readable medium of claim 17, wherein creating the target configuration of cabins within the bin further comprises:
obtaining an image via an image capturing device;
detecting a type of the object captured in the image and classifying the object into a corresponding category of a plurality of categories, using a trained machine learning (ML) model;
generating the input to create the target configuration of cabins within a bin; and
triggering the actuator to move at least one bin splitter of the plurality of bin splitters to reposition the at least one bin splitter within the space defined by the bin to create the target configuration of cabins within the bin, based on the input, wherein triggering the actuator to rotate at least one bin splitter of the plurality of bin splitters comprises:
selecting the at least one at least one bin splitter from the plurality of bin splitters, based on the input; and
requesting a selector device to selectively engage the at least one of the plurality of the bin splitters with the actuator, to reposition the at least one bin splitter within the space defined by the bin to create the target configuration of cabins within the bin.

19. The non-transitory computer-readable medium of claim 17, wherein the computer-executable instructions are further configured for:
upon detecting the type of the object captured in the image, determining a dismantling procedure associated with the object; and
displaying a graphical representation of the dismantling procedure associated with the object, via a display screen, to enable the user to dismantle the object into one or more constituent parts, to thereby enable the user to dump each of the one or more constituent parts into a respective cabin associated with the configuration of the cabins.

20. The non-transitory computer-readable medium of claim 17, wherein the computer-executable instructions are further configured for:
determining an identity of the user captured in the image, using a face recognition model; and
logging a record of dumping of the object by the user in a database.
